(19) United States
(12) Patent Application Publication
(10) Pub. No.: US 2016/0015007 A1
(43) Pub. Date: Jan. 21, 2016

(54) Method and Apparatus for Managing a Bee Hive

(71) Applicant: George Sinanis, West Bloomfield, MI (US)

(72) Inventor: George Sinanis, West Bloomfield, MI (US)

(21) Appl. No.: 14/633,468

(22) Filed: Feb. 27, 2015

Related U.S. Application Data
(60) Provisional application No. 62/025,585, filed on Jul. 17, 2014.

(51) Int. Cl. A01K 47/06; A01K 47/02

(52) U.S. Cl. CPC A01K 47/06; A01K 47/02

(57) ABSTRACT

A hive box is disclosed that includes a wall that defines an opening that is opened and closed by a closure member. The opening and the closure member may span part or all of the width of the wall. A plurality of two-part frames is provided inside the hive box that each include a lower portion and an upper portion. The lower portion of the two part frame is removable or partially removed from the hive box through the opening when the closure member is opened without removing the upper portion of the frame. A sliding connection is provided between the upper portion and the lower portion of the frame. Sensors, other electronics, or a LED and light detector may be provided inside the hive box that create data relating to a condition inside the hive box for transmission to a remote receiver.

### CROSS-REFERENCE TO RELATED APPLICATIONS

This application claims the benefit of U.S. provisional application Ser. No. 62/025,585 filed Jul. 17, 2014, the disclosure of which is hereby incorporated in its entirety by reference herein.

### TECHNICAL FIELD

This disclosure relates to a method for managing bee hives generally and, in particular, monitoring queen bee and brood conditions, checking for diseases or swarm cells, and controlling mites and other pests, and managing honey in bee colonies and to a hive box and frame that are adapted to permit inspection and maintenance of bee colonies and removal of partial or full frames without disassembling the hive boxes.

### BACKGROUND

Bee colonies in hive boxes require periodic inspection and regular management to assure that the hive is healthy and productive. Brood boxes and frames must be inspected or removed to monitor the health of the colony. Checking on the condition of a beehive during the period of honey production is difficult with conventional bee hives because the honey supers are stacked on top and are heavy. The honey supers may weigh as much as 75 pounds each and must be lifted off the hive stack to permit inspection and maintenance of the colony. This is back-breaking and labor intensive work that is time consuming because it should be done throughout the season and especially during the peak honey flow.

Hive management inspection and maintenance is required to verify that the queen bee is present and laying eggs. It is also important to determine whether there are any diseases in the colony, such as varroa mite infestations. Bee colonies are subject to infestation by mites and other pests that can destroy entire bee colonies if they are not controlled. Varroa mites preferentially infest the larger drone brood cells as larva that mature inside the drone brood cells. Once the varroa mites mature they can decimate the entire bee colony.

Mites and other diseases are controlled in several different ways. One approach is to spray the colonies with chemical compositions that control the pests. If the chemicals are not properly applied, the bees may be harmed and the honey can be adversely affected. Another way to control pests, such as varroa mites, is to disassemble the stacked hive boxes, remove the frames with mites, and place the frames in a freezer to kill the mites. However, it is difficult to know if varroa mites are present in a hive box so the hive boxes must be unstacked and restacked on a regular basis just to check on the condition of the colony. Hive boxes are generally stacked vertically and may weigh over 75 pounds each when the frames are full. Stacking and unstacking hive boxes is manual work done in a field and normally without automated lifting equipment.

Applicant's assignee has developed an electrically heated drone frame that can kill varroa mites by heating the drone brood frames in a hive box until the drones and varroa mites die. The dead drones with the varroa mites are then removed from the hive box by worker bees. While this approach has proven to be effective, a simple, less labor intensive, and more cost effective method is needed for controlling varroa mites.

There is a need for a simple and effective method and apparatus for managing bee hives. Managing bee hives includes controlling diseases, pests, and mites; inspecting the colony; and managing honey production without requiring expensive equipment or stacking and unstacking the hive boxes. The method and apparatus for managing the colony is summarized below.

### SUMMARY

A hive box is disclosed that has an opening in at least one side and two-part frames including a frame and a support bar or two frames that allow brood removal through the opening in the hive box. In addition, a method is disclosed for removing brood or comb containing mites or other diseases from the hive box. As used herein, the terms “comb,” “foundation,” and “cells” are synonymous. “Comb” can be empty cells, drone brood or female brood. “Foundation” is generally used to refer to empty cells, but also may include drone cells or female cells. Within the broad description of the apparatus and method outlined above, many variations and additional elements may be incorporated. The following summary is organized to summarize features relating to the hive box, the frames, and the method of controlling diseases, pests, and otherwise managing the colony.

The hive box is generally of conventional design and includes an enclosure having sides, generally four sides, with an open top and open bottom. The top hive box has a top wall and the bottom hive box has a bottom wall. Intermediate hive boxes located between the top hive box and bottom hive box are open on the top and bottom of each box to permit the bees to move up and down through the stack of hive boxes. An entrance is provided adjacent the bottom wall of a hive box that may be the lowest hive box.

According to one aspect of this disclosure, at least one opening is provided in at least one side of the hive box. The opening is formed in a side wall on one end or both ends of the hive box that extend transverse to the length of the frames. The opening has a width that is greater than the width of one frame and also provides clearance to facilitate removing a part of a frame through the opening. The opening may extend across the entire width of the sidewall. The opening extends to the bottom of the side wall and extends upwardly from the bottom of the side wall a distance that may vary depending upon the size of the part of the frame to be removed. A reinforcement may be attached to the bottom of the opening or bottom of the frame spanning the opening to reinforce the side of the hive box where the opening is formed. The opening does not extend to the top of the side wall, for example, the opening may extend to within 1″ of the top of the box. The portion of the hive box above the opening is provided to assure the structural integrity of the frame and to provide a support for suspending the top part.

Two openings may be provided on opposite sides of the hive box on the ends of the side box that extend transverse to the length of the frames. While one opening is sufficient for practicing the method, two openings may be provided to improve visibility, provide access to both sides of the frame part to be removed, to facilitate sliding the frame from the hive box, or to facilitate latching and unlatching the removable part of the frame.

The opening is adapted to be closed by a door that includes a door portion that supports a plug and/or a seal. The door is larger than the opening and includes a peripheral portion that is flush with the side wall around the opening. The plug is configured to fit within the opening in the side wall with a small clearance that is spanned by the seal and has a thickness that may correspond to the thickness of the side wall. If desired, the plug may be formed in a retrofit as the portion of the hive box that is removed to form the opening. The seal extends around the plug on the door and is adapted to seal the gap formed between the plug and the opening in the side wall. Alternatively, the seal can also be placed on the hive box to seal against the cover.

In another embodiment of this disclosure, a hive box is disclosed that includes an entire side wall that is either connected by a hinge and latch to the hive box or otherwise detachably connected to the hive box. The entire side wall is opened or removed to allow for inspection of all of the frames in the hive boxes. Two-part frames are provided that include an upper portion that remains in the hive box when a lower portion of the frame that defines the space for the bees to build combs is removed for hive management activities. The lower portions of the frames are detachably connected to the upper portions of the frames. Once partially or completely removed, the comb in the lower portions of the frames may be removed, inspected, cut, or otherwise treated to manage the colony.

The hive box includes parallel frame hanging rails that extend along the side walls and are transverse to the length of the frame. The parallel frame hanging rails support the frames that have projections, or ears, that suspend the frame from a top portion of the frame within the hive box.

Several variations of frames are usable with the disclosed hive box and method. The frames may be two-part frames including an upper part and a lower part. The frames may have a lower portion of the frame that is substantially larger than the upper portion of the frame to maximize the space within the frame for the bees to build comb. The upper portion of the frame may be a bar or may be a frame that includes starter frame for worker bees to build comb.

If a two-part frame is used in the hive according to the method, a clip, latch or sliding connectors may be used to secure the lower frame part to the upper frame part together in a detachable manner. If a clip or latch is used to secure the top and bottom frames together, a self-locating clip or latch may be provided on one side if the hive box has a single opening in one side.

In one embodiment, a keyhole slot may be provided on one of the two parts of the frame with one or more fasteners that have a head being provided on the other part. In another embodiment, the two parts of the frame may be formed in an extrusion process wherein an extruded track and track receiver are provided on opposite parts of the frame. The extruded shape may be a plastic extrusion or may be cut out of wood, or the like, with a machining process. The extrusion may extend continuously across the whole length of the frame or may be provided in segments that a separated by gaps.

The track may be a T-slot, a C-channel or other extruded shape that may allow the bottom frame part to be removed by sliding or otherwise moving the bottom frame part out of engagement with the upper frame part. The connectors provided on the frames may be installed on either the upper frame or the lower frame. In one alternative, the bottom frame may be attached to the top frame by magnets. The bottom frame part may be a bar, an empty frame, a starter strip, one or more rows for starting the comb, or a full drone brood starter panel disposed in a frame.

About a ¼ to ⅜ inch gap is provided between the upper and lower frame parts to reduce the extent to which the bees can apply propelis that tends to weld the frames together. Limiting or minimizing the accumulation of comb between the frames makes it easier to remove the bottom frame from the upper frame. At least a ¼ inch gap is also provided between the bottom of the lower frame part and the frames of a hive box below the lower frame part.

The frame may include adjustable top and bottom frame parts. The extendable frame may be formed by extrusions that are received telescopically relative to each other to be extended, retracted and locked in place when the frame is set to the proper height and width. Adjustable tabs, or ears, may be provided on the top frame to permit the frame to be adapted to various size hive boxes. Alternatively, an adjustable frame may have extruded horizontal or vertical sides that may be formed within a range of sizes and connected by corner connectors.

The bottom part of the frame that is intended to be removed or partially removed from the hive box may include a handle on one side to facilitate gripping the bottom part of the frame when it is moved and/or inserted into the hive box.

The frame may also include housings for electronic components that may be desirable to incorporate in one or more of the frames. Electronics that may be desirable to include in the frame may include sensors, such as temperature sensors, optics, power sources, transmitters and receivers, digital messaging devices, or the like.

In one embodiment, the frame may support light-emitting diodes (LEDs) and photocells that project visible or infrared light from one side of the frame to another to monitor the extent of completion of the comb. The LED lights (or photo diodes) may be continuously or periodically illuminated so that a photocell at a spaced location on the frame can detect the degree of comb completion as the frame is filled with comb. A single LED/photocell set or optical detector may be provided, or a plurality of LEDs, photo diodes, or a plurality of photocells, or other type of optical detector may be provided on the lower frame. Electronic components may be provided in housings formed in the top of the frame or in the removable or movable bottom frame. In another alternative, electronic components may be placed in a removable enclosure within the hive box.

If a communication device is included in the frame, messages may be communicated by Bluetooth®, Zigbee®, cell phone, or other digital communication systems to a central controller. Communication system messages may be sent by cellphone, e-mail, text, uploaded to a server, or an alarm may be actuated by sensors within the hive box that are disposed in the hive or on the frame. If a communication system is provided, it may be possible to log service calls and status indications identifying the frames with a unique identification code for sending reports as to the status of hive management efforts.

One disclosed method may be practiced by providing a removal hole in the side of a hive box that is selectively opened and closed with a cover door. The cover door may be connected to the hive box by a hinge or may be secured with clips, fasteners or other types of latching devices. The cover includes a plug to fill the opening in a hive box and a seal to prevent entry of air, light or moisture through the side of the hive box. In some instances, it may be necessary to cut away propelis to remove the door. The cover is removed from the hive box to provide access to a frame part that is adapted to be removed or partially removed from the hive box after comb that may include disease or pests, such as mites, accumulates on the removable portion of the frame. The removable portion of the frame is removed through the opening in the side of the hive box. The door is then closed and the removed comb may be treated, cut out, discarded or otherwise disposed of with the mite larvae remaining intact within the drone brood cells. The bottom part of the frame is reattached to the upper part of the frame with the door open and the door is closed after the lower frame part is reattached.

In another disclosed method, the lower portion of the entire side of a hive box may be selectively opened and closed by a removable panel or hinged panel. The removable portion of the side wall may be connected to the hive box by a hinge and latch or may be secured with other types of latching devices. The removable portion of the side wall, or panel, may include a plug that is received within the hive box and a seal for preventing the entry of air, light or moisture around the side wall of the hive box. The side wall of the hive box includes a top portion that extends across the length of the side wall above the opening.

The removable portion of the side wall may be removed or opened from the hive box to provide access to all of the lower frame parts that are adapted to be removed from the hive box after pests or disease accumulates on the removable lower portion of the frame. The removable portion of the frames may be removed or partially removed through the side of the hive box. The side wall may then be closed with the diseases and pests remaining intact within the comb. The diseased portions of the hive are disposed of that are on the frames. The bottom parts of the frames are then reattached to the upper parts of the frames and the side wall may be closed. The removable portion of the frame can be removed to collect honey.

The above aspects and other aspects of the apparatus and method are described in greater detail in the following detailed description of the illustrated embodiments with reference to the attached drawings.

### BRIEF DESCRIPTION OF THE DRAWINGS

FIG. 1 is a perspective view of a bee hive including a plurality of hive boxes with one hive box having an opening in one side that may be closed by a detachable door that is shown exploded away from the opening;

FIG. 2 is a fragmentary perspective view showing the door detached from the opening with a lower portion of a two-part frame shown in position to be inserted in the direction shown by the arrow into the hive box;

FIG. 3 is a cross-sectional view taken along the line 3-3 in FIG. 1;

FIG. 4 is a fragmentary perspective view of a hive box showing a lower part of a foundationless frame in position to be inserted into the hive box through the opening;

FIG. 5 is a fragmentary perspective view showing the lower frame inside the hive box and attached to an upper frame;

FIG. 6 is a fragmentary perspective view of a hive box showing the lower frame filled with comb being removed from the hive box;

FIG. 7 is a front elevation view of another embodiment of a two-part frame including an upper frame bar and a lower frame including a comb starter panel;

FIG. 8 is a fragmentary perspective view of a portion of the upper frame exploded away from a portion of the lower frame;

FIG. 9 is a fragmentary perspective view of an extruded upper frame with a lower frame portion including a headed protrusion aligned with a slot in the upper frame;

FIG. 10 is an alternative embodiment of an adjustable two-part frame made of interlocking extrusions and corner connectors;

FIG. 11 is an alternative embodiment of an adjustable two-part frame that is formed by telescoping L-shaped frame parts;

FIG. 12 is a front elevation view of a two-part frame that is equipped with a sensor and a LED-photo diode cell or other type of detection system may be used to monitor comb development;

FIG. 13 is an electronic control diagram illustrating a photo detection circuit for monitoring comb growth;

FIG. 14 is a diagrammatic illustration of a system for communicating data from a bee frame to a communication network;

FIG. 15 is a perspective view of an alternative embodiment of a hive box that has an opening spanning the side wall that is closed by a panel and includes an upper portion that is not removable;

FIG. 16 is a perspective view of the embodiment of FIG. 15 with the removable portion of the side wall open and a plurality of lower frame parts shown partially or fully removed from the hive box through the opening in the side wall; and

FIG. 17 is a perspective view of the embodiment of FIG. 15 with the removable portion of the side wall open and a plurality of lower frame parts shown disposed within the hive box with the panel removed from the hive box to expose the opening in the side wall (the panel is also shown in phantom hanging from the top of a hive box immediately below the illustrated hive box.

### DETAILED DESCRIPTION

The illustrated embodiments are disclosed with reference to the drawings. However, it is to be understood that the disclosed embodiments are intended to be merely examples that may be embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

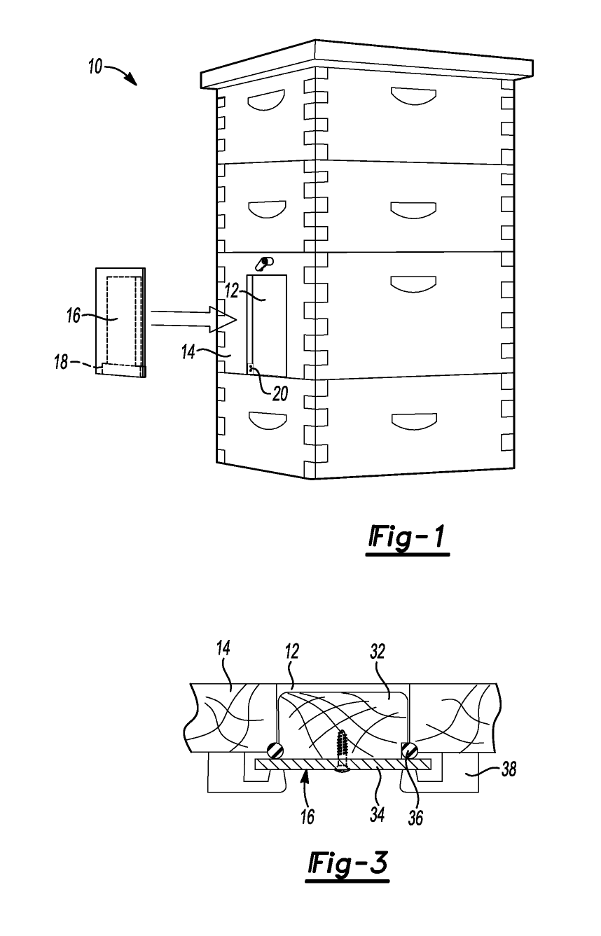

Referring to FIG. 1, a set of hive boxes 10 are illustrated as they would be set up in the field. One of the hive boxes 10 includes an opening 12 in a wall 14. The opening 12 may be opened and closed by a door 16 that fits tightly into the opening 12, as will be described in greater detail with reference to FIG. 3. The door 16 includes base extensions 18 that are provided to ensure a tight fit between the door 16 and the opening 12 at the base of the door 16. The base extensions 18 may be attached to the base of the opening instead of the base of the door, if desired.

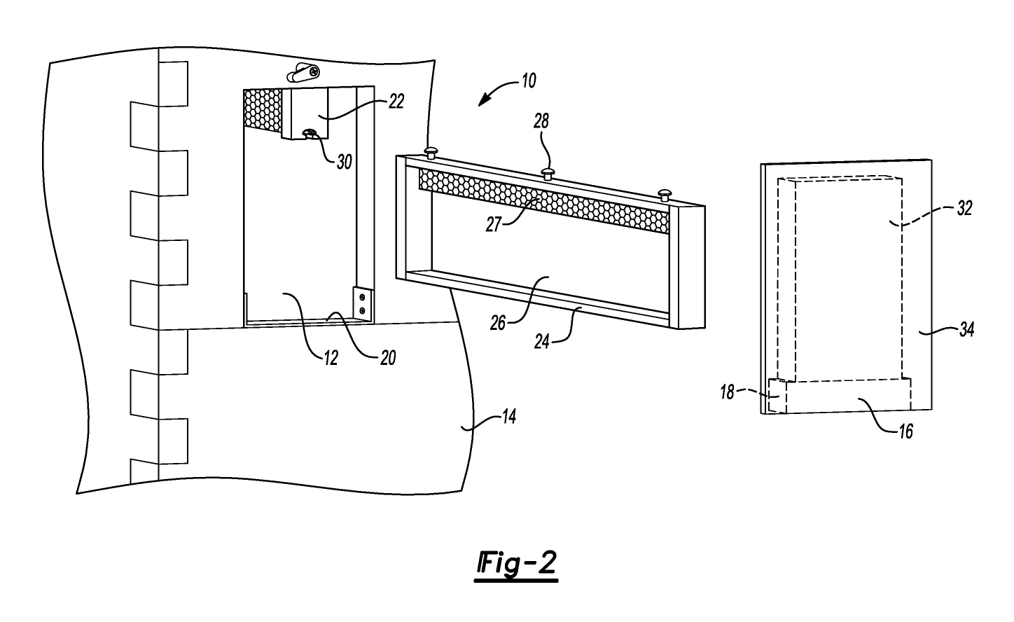

Referring to FIG. 2, the hive box 10 including the opening 12 in the wall 14 is illustrated with the door 16 removed. The door 16 includes base extensions 18 that are provided to improve the fit between the door 16 and the opening 12 at the bottom of the opening 12. An optional reinforcement strip 20 is shown to be attached to the lower end of the opening 12 that reinforces the hive box 10 below the opening 12. The reinforcement strip may be omitted and the bottom of the opening may be open to the hive box below the hive box 10. The reinforcement strip 20 may perform the function of the extensions 18 to improve the fit between the door 16 and the opening 12.

An upper frame 22 is shown disposed within the hive box 10 that extends downwardly from the top of the opening 12. A lower removable frame 24 is shown removed from the hive box 10 and detached from the upper frame 22. The lower frame 24 includes an opening 26 that is provided to promote building comb within the opening 26. The opening 26 may be left empty or may be provided with a foundation panel or a starter strip 27 as illustrated.

In one embodiment, the lower frame 24 includes a plurality of headed fasteners 28 that are secured to the lower frame 24 and adapted to be inserted in a sliding relationship into a keyhole slot 30 formed in the upper frame 22. The lower frame 24 is inserted into the hive box 10 with the headed fasteners 28 aligned with the keyhole slot 30. The lower frame 24 is then secured to the upper frame 22 by sliding the headed fasteners 28 through the keyhole slot 30. Alternatively, the headed fasteners could be provided on the upper frame 22 and the keyhole slot could be provided on the lower frame 24.

Referring to FIGS. 2 and 3, the door 16 includes a plug 32 that corresponds in shape and size to the opening 12 in hive box 10. A clearance is provided around the plug relative to the opening 12. A cover 34 extends beyond the opening and is attached to one side of the plug 32. The cover 34 may have a peripheral portion that overlies the wall 14 around the opening 12 in a face-to-face arrangement. A seal 36 is assembled to the plug 12 and cover 34 to provide a seal in conjunction with the base extensions 18 that prevents light or moisture from penetrating the opening 12. A plurality of clips 38 may be used to secure the door 16 to the wall 14 of the hive box 10. The clips 38 that are illustrated are pivotal clips that are secured by a fastener.

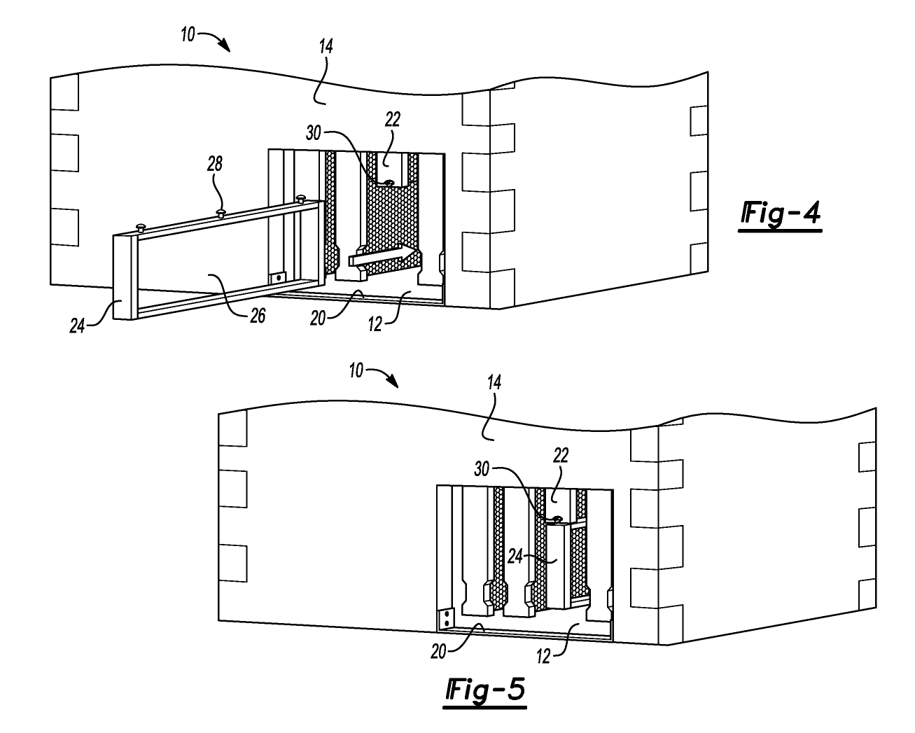

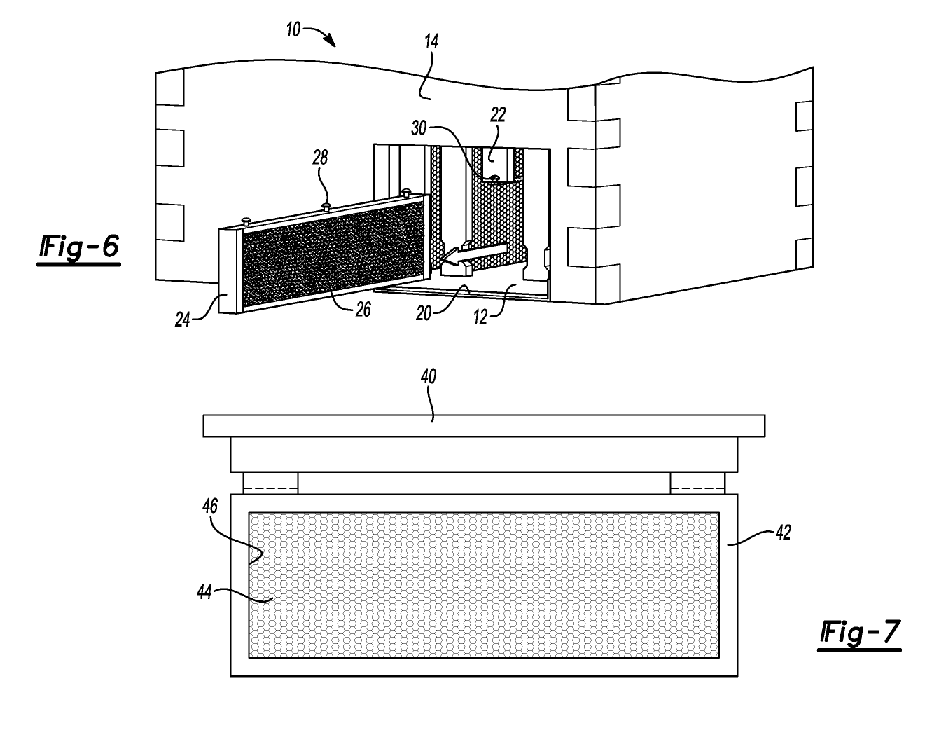

Referring to FIGS. 4-6, a sequence of views is provided beginning with a view showing a foundationless or with foundation frame ready to be inserted in the hive box in FIG. 3. It should be understood that while a foundationless frame is illustrated, a frame with a foundation could be used. Referring to FIG. 4, the lower frame 24 is shown attached to the upper frame 22 with the lower frame being supported by the headed fasteners 28 that are received in the keyhole slot 30. The bottom of the opening 12 is reinforced and bordered by the reinforcement strip 20. It should be noted that some clearance is provided between the bottom of the lower frame 24 and the reinforcement strip 20 or the top of the next lower hive box if there is no reinforcement strip to allow for removal of the lower frame 24. Referring to FIG. 6, the hive box 10 is shown with the foundationless frame or lower frame 24 being removed from the hive box 10 with comb built up within the opening 26. The headed fasteners 28 are removed by sliding the frame in the direction shown by the arrow through the keyhole slot 30.

Two openings may be provided at opposite sides of the hive box 10. If two openings are provided, the lower frame 24 may be removed from either side or different types of latching mechanisms can be used. It should be understood that many different fastening mechanisms may be used to attach the lower frame 42 to the upper frame 40 in a sliding relationship or in an otherwise detachable relationship.

Referring to FIG. 7, an alternative embodiment of a two-part frame is shown that includes an upper supporting frame 40 and a lower movable or removable frame 42. The upper supporting frame 40 may or may not include an area for comb formation. The lower removable frame 42, shown in FIG. 7, is provided with a comb foundation panel 44.

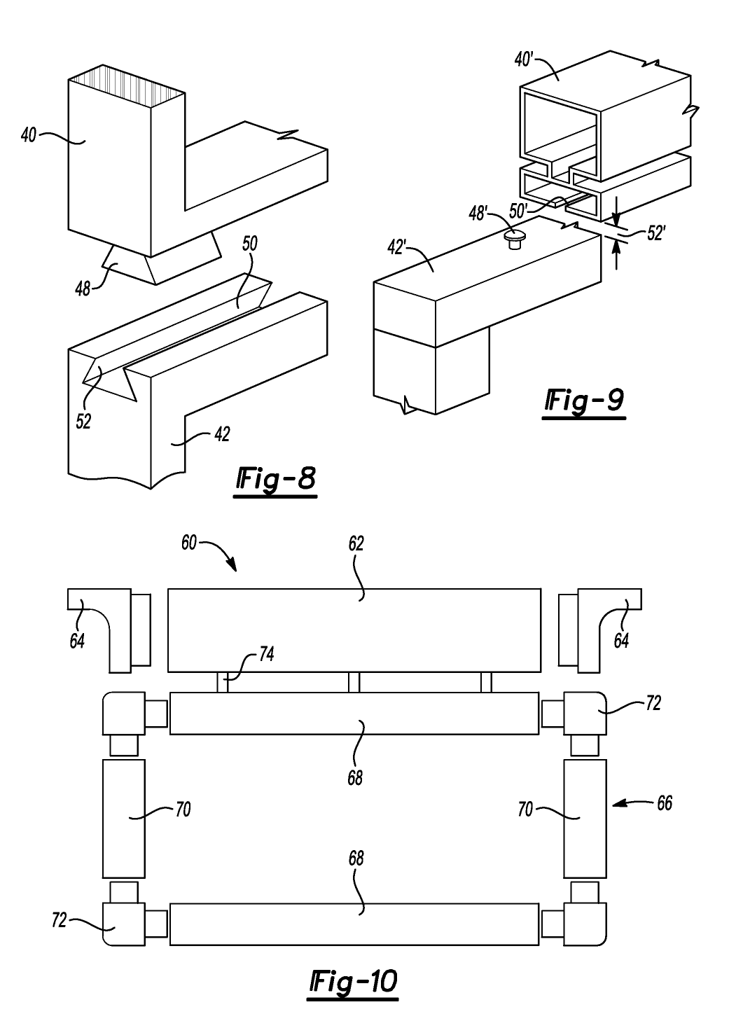

Referring to FIG. 8, the upper supporting frame 40 is shown separated from the lower frame 42. A retention shoe 48 is shown separated from a retention slot 50 defined by convergent sides 52 that define the retention slot 50 within the upper portion of the lower frame 42.

As shown in FIG. 8, the lower frame 42 is supported by the upper frame 40. The retention shoe 48 is disposed within the retention slot 50 with the convergent sides 52 of the retention slot 50 being supported on divergent sides of the retention shoe 48.

The lower frame 42 is readily assembled by sliding the lower frame 42 into engagement with the upper frame 40 even after the accumulation of the comb, such as drone brood, in the lower frame 42. A gap is provided between the upper frame 40 and the lower frame 42 when assembled.

The propelis or beeswax does not interfere with the removal of the lower frame 42 because the width of the gap discourages the build-up of propelis or beeswax. A gap of at least ¼″ is provided between the upper frame part and the lower frame part to limit the build-up of comb and facilitates moving the lower frame part.

Referring to FIG. 9, an alternative embodiment of a frame assembly is shown that includes an upper frame part 40′ shown separated from the lower frame part 42′. A headed protrusion 48′ is shown separated from a retention slot 50′ defined by the upper frame part 40′. A gap 52′ is defined between the upper frame part 40′ and the lower frame part 42′ to discourage formation of propelis bridging the parts. The gap 52′ is preferably at least ¼ inch wide to limit the deposit of propelis or beeswax in the slot that would interfere with the sliding fit between the upper frame part 40′ and the lower frame part 42′. Difficulty may be encountered when removing the lower frame part 42′ if the gap is less than ¼ inch.

The frame parts 40′ and 42′ may be formed as a plastic extrusions or may be formed from a rigid structural member such as wood, plastic or metal bars that are formed by conventional tools and assembly processes.

Referring to FIG. 10, a two-part interlocking adjustable frame 60 is illustrated that includes an upper bar 62 that extends between hanger bars (not shown) on the sides of a hive box 10 (shown in FIG. 1). The length of the upper bar 62, or upper frame part, may be changed by changing the length of an extrusion used to form the upper bar 62. The tabs 64 are assembled to opposite ends of the upper bar 62 and are used to hang the frame 60 from hanger bars on the sides of the hive box 10. A lower interlocking frame 66 is provided that is made up of parallel transverse bars 68 and parallel vertical bars 70 that are secured together by a plurality of corner connectors 72. The size of the frame 60 may be adjusted by changing the length of the transverse bars 68 and the vertical bars 70.

The lower interlocking frame 66 is suspended from the upper bar 62 by hanging fasteners 74. For example, the headed fastener 28 and keyhole slot in FIGS. 1-6 may be used. Alternatively, the retention shoe 48 and retention slot 50, as described with regard to FIGS. 6-8, may be used to connect the upper bar 62 and lower frame 66. Many other types of hanging arrangements are possible that can be used to connect the lower frame 66 to the upper bar 62 with a sliding fit or detachable connection. The upper bar 62 and lower frame 66 do not need to slide on each other, but may also be separated from each other and moved relative to the other part in the lengthwise frame direction.

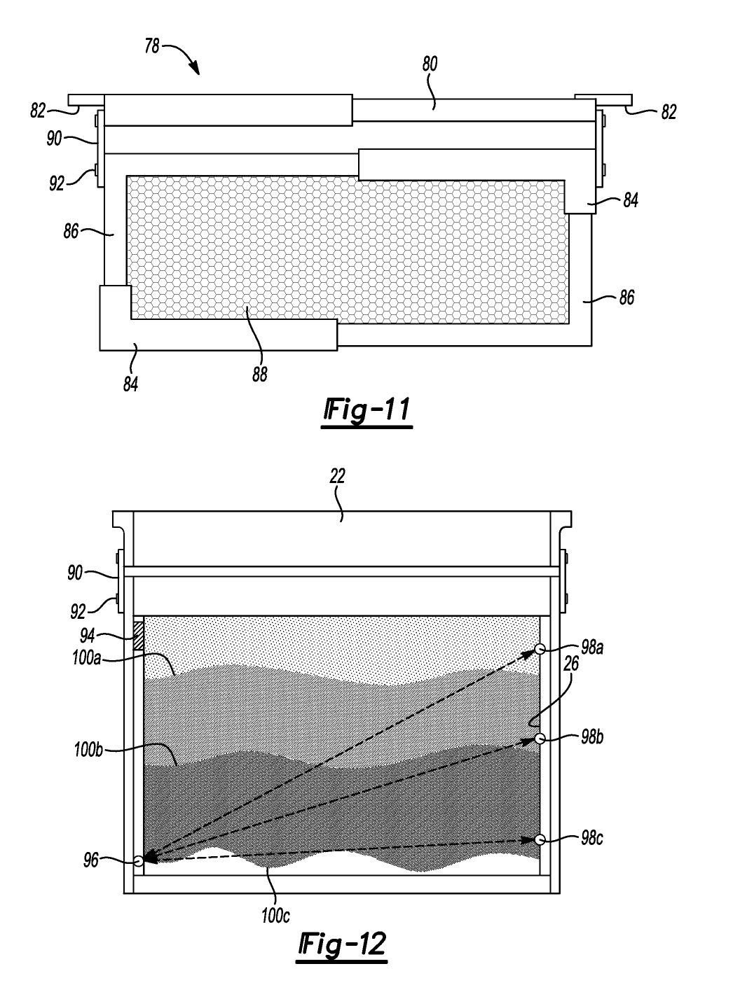

Referring to FIG. 11, another alternative embodiment of a two-part frame is shown to comprise a telescoping adjustable frame 78. The adjustable frame 78 is attachable to an upper bar 80 that is flanked by tabs 82. The tabs 82 are used to support the upper bar 80 and the adjustable frame 78 on hanger bars within the hive box 10 (shown in FIG. 1). The adjustable frame 78 includes two outer L-shaped frame parts 84 and two inner L-shaped frame parts 86 that are attached together in a telescopic relationship. The inner L-shaped frame parts 86 are received within the outer L-shaped frame parts 84 and may be adjusted to meet the requirements of various size hive boxes.

The frame parts 84 and 86 are shown with a drone brood foundation 88 that is attached within the frame parts 84 and 86. It should be understood that a foundationless frame may be provided or the frame may be provided with a starter strip, such as a drone brood starter strip. The starter strip may include one or two rows of cells.

Referring to FIG. 12, another alternative embodiment is shown of a two-part frame including an upper frame 22 and a lower frame 24. The lower frame 24 defines an opening that may be foundationless or may include a foundation panel or starter strip. A sensor 94 may be provided in the lower frame 24 for sensing various conditions within the hive, such as the temperature or any other condition that may be indicative of the status of the brood development. A photo diode 96 or LED is shown in the lower left side of the lower frame 24 opposite three photo cells 98a, 98b, and 98c in the right side of the frame 24 that comprise photo cells that detect light emitted from the photo diode or LED 96. The arrows shown with dotted line indicate the light propagated from the photo diode 96. The light may be visible light or infrared light.

Development of the comb is indicated in three phases denoted 100a, 100b and 100c. The comb 100 is formed beginning at the top of the lower frame 24 opening 26 and proceeds downwardly. The photo cell 98a is obscured when the drone brood reaches line 100a of development. When the comb develops to 100a, the light available to photo cell 98a is impaired and the signal is generated, or interrupted, to indicate light blockage. As the comb development continues to the 100b level, the photo cell 98b becomes obscured from the source of light 96. Finally, as comb development continues to near completion, the photo diode 98c becomes obscured and the photo diode may signal that the comb formation is nearly complete. At this time, the lower frame 24 may be detached from the upper frame 22 by pivoting hanger latches 90 to disengage latch pins 92. When the latches 90 are pivoted free of the latch pins 92, the lower frame 24 may be removed or accessed by sliding the lower frame 24 relative to the upper frame 22.

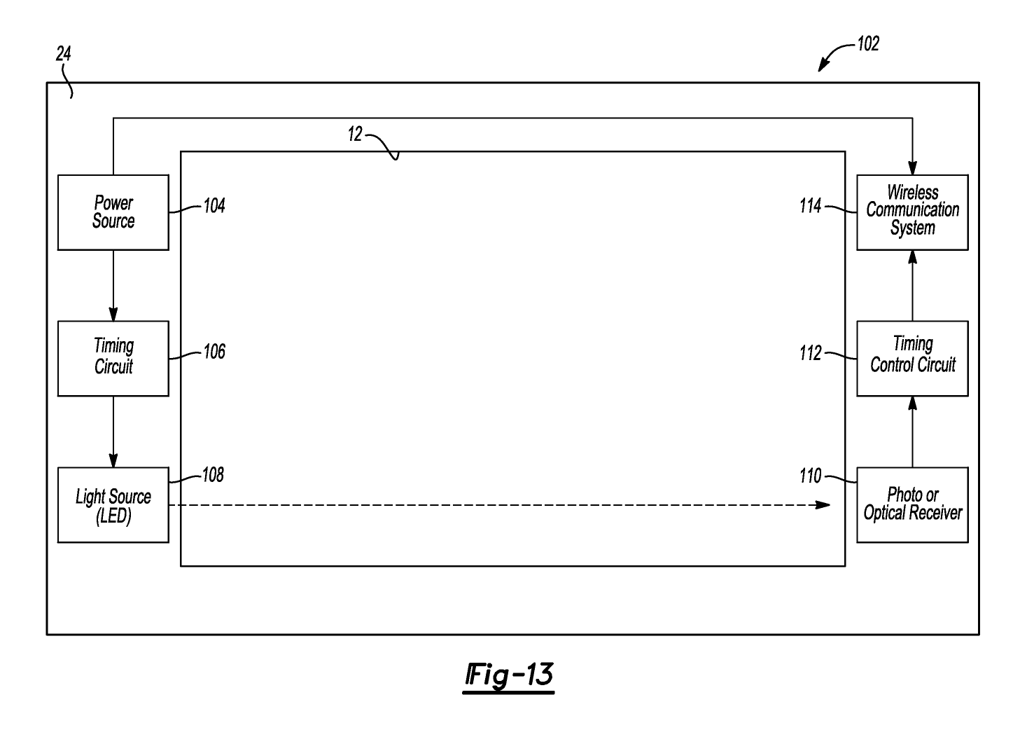

Referring to FIG. 13, an electronic control diagram 102 is presented that illustrates how the two-part frame may be used to include a photo detection circuit for determining the extent of comb growth. A power source 104 may be included within the lower frame 24 or the upper frame 22. The power source 104 may be used to provide power to a timing circuit 106 that periodically actuates a light source or LED at 108. The power source 104 also provides power to a photo cell or optical receiver at 110 that receives light (infrared or visible light) from the light source 108. The photo or optical receiver provides at 110 a signal to a control circuit 112. The control circuit 112 monitors the signals from the photo or optical receiver 110 to determine whether pulses are received from the light source 108 in accordance with the predetermined timing set by the timing circuit 106. For example, to preserve battery power, a LED may be illuminated every 3 hours for several minutes. If the timing control circuit 112 does not receive an indication that the photo or optical receiver 110 received a light transmission at a predicted interval, the timing control circuit 112 communicates that the drone brood is built to the level corresponding to the level of the photo or optical receiver 110. The wireless communication system collects data at 114 from the frame 24.

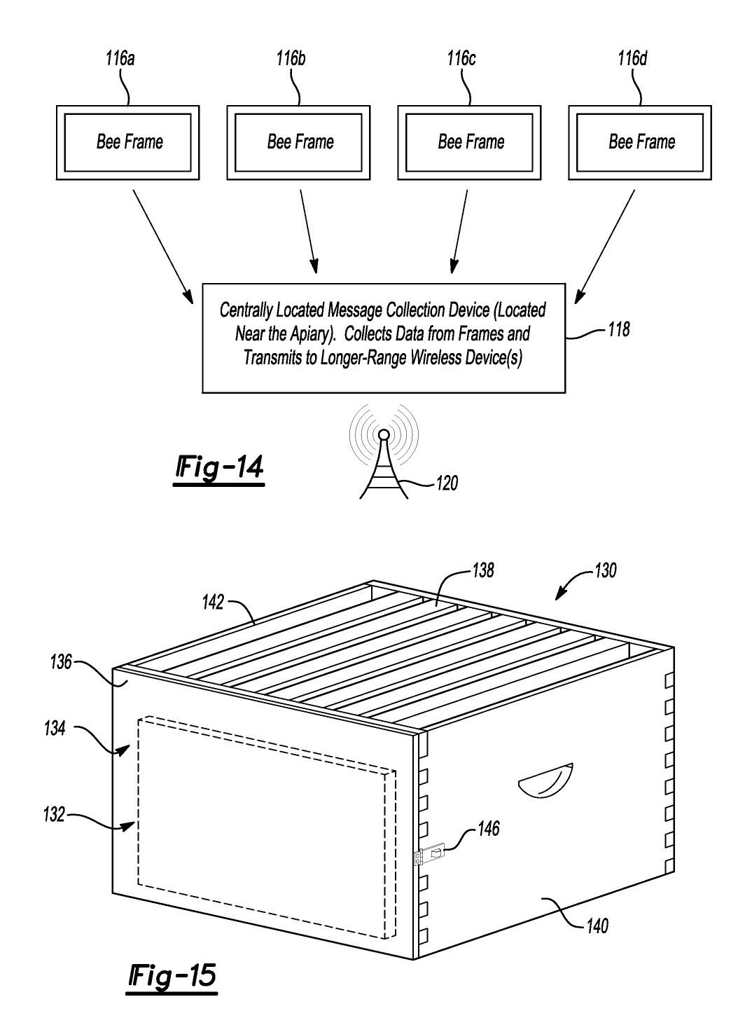

Referring to FIG. 14, a system for communicating with the bee frame 116 is illustrated diagrammatically. Bee frames 116a, 116b, 116c and 116d each independently communicate with the centrally located data collection system 118. The data collection system 118 receives and collects data signals from the wireless communication system described with reference to FIG. 12 and provides the data to the data collection system 118. The data collection system 118 is connected to a communication network 120 that may be wired, wireless, or the like. The network communicates over long distances regarding the condition and the development of the comb within the two-part frames corresponding to the bee frames 116a-116d. Data collected by sensors disposed on the frames or in the hive box is provided to a transmitter inside the hive box to the message center at 118.

Referring to FIG. 15, an alternative embodiment of a hive box 130 is shown with a removable panel 132 attached to the hive box 130 to complete a side wall generally indicated by 134. A top portion 136 of the side wall 134 is not removable and is connected to adjacent walls of the hive box 130. A plurality of frame assemblies 138 are shown assembled within the hive box 130. The frame assemblies 138 extend in a parallel direction relative to a front wall 140 and a rear wall 142 of the hive box 130. A latch 146 is shown securing the removable panel 132 to the front wall 140.

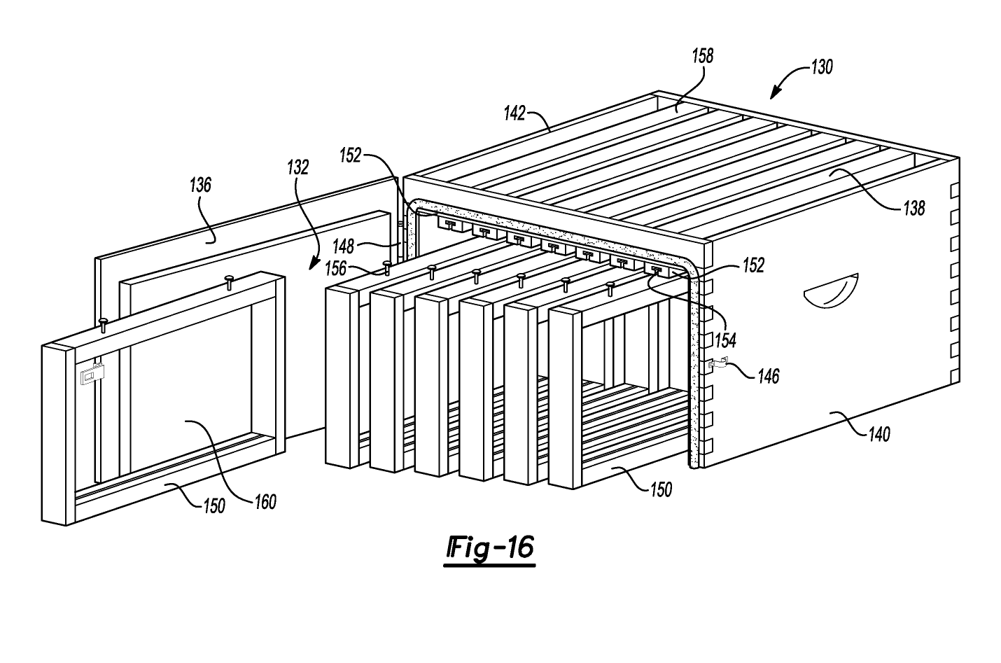

Referring to FIG. 16, the hive box 130 is shown in its open condition with the removable panel 132 shown pivoted on a hinge 148 to its open position. The top portion 136 of the side wall is shown as it is retained on the hive box 130 connected to the front wall 140 and rear wall 142. The frame assemblies 138 are shown partially removed with a plurality of lower frame parts 150 shown being partially or fully removed from the upper frame parts 152. The upper frame parts 152 are retained inside the hive box on frame tabs (not shown) that are adapted to hang from frame supports (not shown) provided on the hive box 130 as is conventional with one-piece bee frames and hive boxes.

The frame assemblies 138 are assembled into the hive box 130 when no boxes are stacked thereon by inserting the frame assemblies 138 through a top opening 158 defined by the hive box 130. The frame assemblies 138 are suspended by hanger tabs on the frame supports provided inside the top portion of the hive box 130. While the hive box and frame shown in FIG. 16 are all two-part frame assemblies 138, it should be understood that one or more conventional frame assemblies may be used in place of one or more of the frame assemblies 138.

The lower frame parts 150 are secured to the upper frame parts 152 by inserting the headed protrusions 156, or headed fasteners, into the receptacle 154, or keyhole slot, defined by the upper frame part 152. The lower frame part 150 defines an opening 160. Bees form comb within the opening 160. The opening 160 may also include a foundation panel as previously described with reference to FIG. 7.

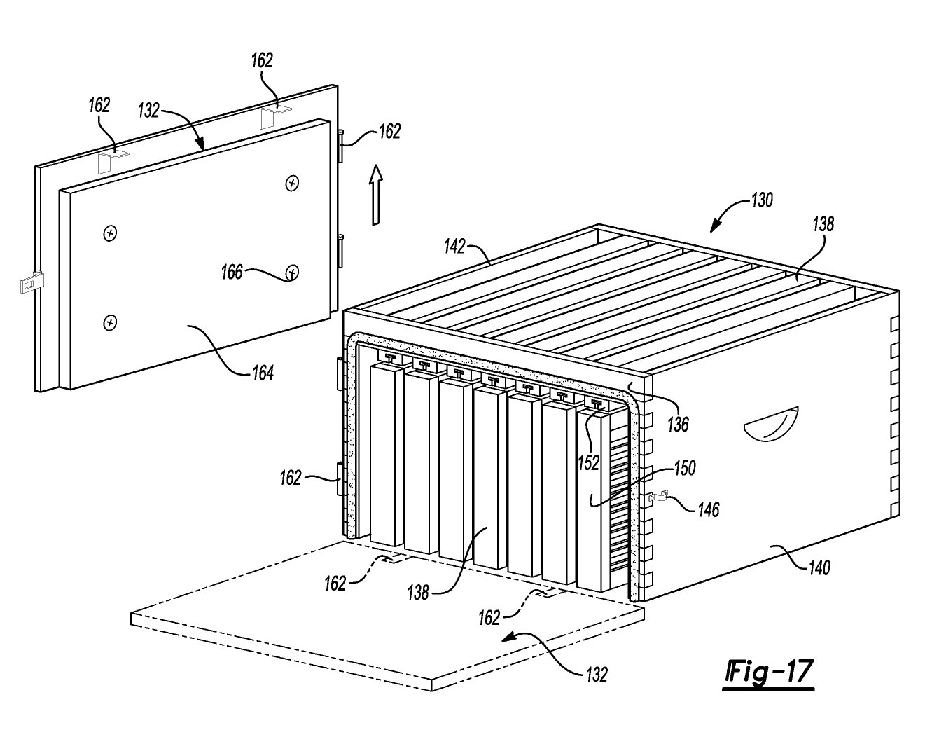

Referring to FIG. 17, the hive box 130 is shown with a removable panel 132 being removed from the hive box 130. The removable panel 132 and hive box 130 are provided with two parts of a separable hinge 162 that permits the removable panel 132 to be lifted off of the part of the separable hinge 162 on the hive box 130. The inner side of the removable panel 132 includes a plug 164. The plug 164 is attached to the removable panel 132 by fasteners 166 that may be assembled from the inside or the outside of the removable panel 132. The plug 164 may include a seal and may be constructed generally in accordance with the door 16, as shown in FIG. 3, that included the plug 32, cover 34 and seal 36.

The removable panel 132 may be provided with hangers 162. The hangers 162 may be used to hang the removable panel 132 on the next lower hive box to provide a working surface and prevent the queen been from falling on the ground or dropping any of the lower frame parts 150 on the ground.

With continuing reference to FIG. 17, the lower frame parts 150 are shown fully inserted in the hive box 130 with the lower frame parts 150 being suspended from the upper frame parts 152 by the headed protrusions 156 that are received in the receptacle 154 defined by the upper frame parts 152. The latch shown on the front wall 140 cooperates with the separable hinges 162 that are attached to the rear wall 142 of the hive box 130 to detachably secure the removable panel 132 to the hive box 130.

The embodiments described above are specific examples that do not describe all possible forms of the discourse. The features of the illustrated embodiments may be combined to form further embodiments of the disclosed concepts. The words used in the specification are words of description rather than limitation. The scope of the following claims is broader than the specifically disclosed embodiments and also includes modifications of the illustrated embodiments.

What is claimed is:

1. A bee frame assembly for a hive box having frame supports on opposite side walls, wherein one of the sidewalls defines an access opening that is closable with an access panel, the bee frame assembly comprising:
an upper frame part suspended from the frame supports by a pair of frame tabs; and
a lower frame part movable relative to the upper frame part to be at least partially removable from the hive box through the access opening, and wherein the upper frame part is retained within the hive box on the frame supports when the lower frame part is moved through the access opening when the access panel is open.

2. The bee frame assembly of claim 1 further comprising:
a protrusion provided on one of the frame parts; and
a receptacle provided on the other one of the frame parts, wherein the lower frame part is detachable from the upper frame part by sliding the frame part having the protrusion relative to the receptacle to remove the frame part having the protrusion from the frame part having the receptacle.

3. The bee frame assembly of claim 2 wherein the protrusion further comprises a plurality of fasteners that each include a head and the receptacle is a keyhole slot.

4. The bee frame assembly of claim 2 wherein the protrusion includes a head portion that is connected to one of the frame parts by a neck portion, and the receptacle defines a slot having an enlarged portion in the other one of the frame parts for receiving the head portion and having a reduced width portion for receiving the neck portion.

5. The bee frame assembly of claim 1 wherein the lower frame part is formed by vertically extending bars and horizontally extending bars that are both adjustable telescopically, and wherein the vertically extending bars and the horizontally extending bars are assembled to corner parts, and wherein the vertically extending bars and the horizontally extending bars are provided in a range of lengths.

6. The bee frame assembly of claim 1 wherein the lower frame part further comprises:
a first vertically extending bar that supports a light source;
a second vertically extending bar that supports a light detector and is adapted to detect the extent of growth of comb within the lower portion of the frame.

7. A hive box comprising:
a plurality of vertical walls including a first side wall and a second side wall that defines an opening spanning at least a portion of the width of the second side wall;
a closure panel that is adapted to be inserted into the opening in a closed condition and is adapted to provide access to a space within the hive box in an open condition; and
a plurality of frame assemblies suspended from the hive box that extend between the first side wall and the second side wall, at least some of the frame assemblies include an upper frame part and a lower frame part, wherein the lower frame part is separable from the upper frame part, wherein the lower frame part is at least partially removable from the hive box through the opening with the upper frame part being retained within the hive box.

8. The hive box of claim 7 wherein the opening extends across only part of the width of the second side wall and the closure panel is a door that extends across the opening in the side wall.

9. The hive box of claim 8 wherein the closure panel includes a plug that is received in the opening in alignment with the second side wall and a cover panel that is attached to the plug, wherein the cover panel extends outboard from the plug to span a gap between the plug and the opening, and wherein the panel extends over a portion of the side wall around the opening.

10. The hive box of claim 9 further comprising:
a seal attached to the closure panel adjacent the plug that seals the gap between the plug and the opening.

11. The hive box of claim 7 wherein the opening extends across the entire width of the second side wall and the closure panel extends across the entire width of the side wall, wherein the closure panel includes a plug that is received in the opening between the front wall and the rear wall, wherein the plug includes a seal attached to the closure panel adjacent the plug that seals the gap between the plug and the opening.

12. The hive box of claim 11 further comprising:
a hinge provided between the side wall and a first end of the closure panel; and
a latch provided on the side wall and a second end of the closure panel, wherein the latch is released to permit the closure panel to pivot on the hinge between the open condition and the closed condition.

13. The hive box of claim 7 wherein the second side wall includes a top portion above the opening, and wherein the opening extends downwardly from the top portion to a bottom edge of the hive box.

14. The hive box of claim 7 further comprising:
a reinforcing strip that spans the opening at the bottom edge of the hive box.

15. The hive box of claim 7 wherein the lower portion of the frame further comprises:
a first vertically extending bar that supports a light source;
a second vertically extending bar that supports a light detector and is adapted to detect the extent of growth of comb within the lower portion of the frame.

16. The hive box of claim 7 further comprises:
a sensor disposed within the hive box that detects a condition within the hive box.

17. The hive box of claim 16 further comprising:
a transmitter disposed within the hive box that transmits data from the sensor inside the hive box to a remote receiver.

18. A method of managing a bee hive comprising;
providing a hive box having a side wall that defines an access opening that is closable with an access panel;
providing a bee frame that includes an upper frame part and a lower frame part;
opening the access panel;
moving the lower frame part relative to the upper frame part through the access opening;
inspecting or treating the lower frame part;
replacing the lower frame part or a replacement lower frame part in the hive box; and
closing the access panel.

19. The method of claim 18 further comprising:
servicing the lower frame part after the inspecting step by treating the comb in the lower frame part.

20. The method of claim 19 wherein the step of treating the comb consists of:
cutting away comb;
freezing comb; and
replacing the frame with a replacement frame.
